(19) United States
(12) Patent Application Publication
(10) Pub. No.: US 2009/0146981 A1
(43) Pub. Date: Jun. 11, 2009

(54) LIGHT DETECTION SYSTEM AND RELATED METHOD

(76) Inventors: Chi-Wen Chen, Hsin-Chu (TW); Ming-Sheng Lai, Hsin-Chu (TW); Min-Feng Chiang, Hsin-Chu (TW); Po-Yuan Liu, Hsin-Chu (TW)

Correspondence Address: NORTH AMERICA INTELLECTUAL PROPERTY CORPORATION, P.O. BOX 506, MERRIFIELD, VA, 22116, US

(21) Appl. No.: 12/104,449

(22) Filed: Apr. 17, 2008

(30) Foreign Application Priority Data
Dec. 6, 2007 (TW) 096146481

(51) Int. Cl. G09G 5/00

(52) U.S. Cl. 345/207

(57) ABSTRACT

The present invention provides a light detection system essentially including a light detection circuit for generating a light detection signal by performing a light detection process, an integration-period control circuit for generating a control signal based on the light detection signal, and an integration circuit for adjusting an integration period based on the control signal and generating a readout signal by performing an integration process on the light detection signal during the adjusted integration period. The present invention further provides a light detection method essentially including providing a plurality of integration periods, generating a light detection signal by performing a light detection process, selecting an integration period out of the provided integration periods based on the light detection signal, and generating a readout signal by performing an integration process on the light detection signal during the selected integration period.

### BACKGROUND OF THE INVENTION

1. Field of the Invention

The present invention relates to a light detection system and related method, and more particularly, to a light detection system and related method capable of adjusting the length of an integration period.

2. Description of the Prior Art

Flat panel displays are widely employed in various consumer products such as computer monitors, liquid crystal televisions, plasma televisions, cellular phones, personal digital assistants, digital cameras, display panel of portable game machines, and touch panel of automatic transaction machines. Hence, how to adjust the color and brightness of the flat panel display for meeting forthcoming demands for advanced performances required by customers has become an important task. Most of existing displays include photo detectors for detecting light. By adjusting color and brightness of the display in response to a change of the light, consumers would perceive a much better visual experience.

Please refer to FIG. 1, which is a prior art light detection system 100 for use in a display apparatus. The light detection system 100 comprises a light detection circuit 180, a readout line 125, and an integration circuit 190. The light detection circuit 180 comprises a photo-inducing element 110 and a readout element 120. In a preferred embodiment, the photo-inducing element 110 is a phototransistor, and the readout element 120 is a readout transistor. The integration circuit 190 comprises an amplifier 130, a feedback capacitor Cfb, and a controllable switch 150. The light detection circuit 180 is disposed in a pixel area 101, which is defined by adjacent gate lines 105, 115 and adjacent data lines 106, 116. The photo-inducing element 110 is coupled between the gate line 105 and the readout element 120. The readout element 120 is further coupled to the gate line 115 and the readout line 125. The readout element 120 is utilized to control outputting of the photocurrent Iph induced by the photo-inducing element 110. The photocurrent Iph is furnished to the integration circuit 190 via the readout line 125. The feedback capacitor Cfb in conjunction with the amplifier 130 functions to generate a readout voltage Vout according to the charges accumulated on the feedback capacitor Cfb due to the photocurrent Iph. The integration relationship between the readout voltage Vout and the photocurrent Iph can be provided according to the following expression.

$$Vout = \frac{1}{{C}_{fb}} {\int }_{To}^{To + Td} {I}_{ph} d t$$

In the expression given above, To represents an initial time for integration, and Td represents an integration period. The on/off state of the controllable switch 150 is controlled by a control signal Sctrl. The controllable switch 150 is turned on for performing a discharging operation corresponding to the feedback capacitor Cfb for resetting the readout voltage Vout at the end of the integration period Td. In general, the integration period Td is fixed for the operation of the prior art light detection system 100. During the integration period Td, the readout voltage Vout is boosting in response to the increasing charges accumulated in the feedback capacitor Cfb due to the photocurrent Iph

Please refer to FIG. 2, which is a timing diagram schematically showing the relationship of the readout voltage Vout versus time based on different photocurrents under operations of the light detection system 100 in FIG. 1, having time along the abscissa. Three relation curves 210, 220 and 230 in FIG. 2 are corresponding to three photocurrents Iph1, Iph2 and Iph3 respectively. The photocurrents Iph1, Iph2 and Iph3 are indexed according to increasing magnitude of the photocurrent Iph. Besides, there are three integration periods Td1, Td2 and Td3 shown in FIG. 2. The integration periods Td1, Td2 and Td3 are also indexed according to increasing length of the integration period Td. Based on the integration period Td1, the readout voltages Vout generated by the integration circuit 190 according to the photocurrents Iph1, Iph2 and Iph3 are the corresponding voltages V1, V2 and V3 respectively. Obviously, none of the readout voltages V1, V2 and V3 have reached the saturation voltage Vsat, and hence the readout voltages V1, V2 and V3 can be used to measure the corresponding intensities of the detected light. Based on the integration period Td2, the readout voltages Vout generated by the integration circuit 190 according to the photocurrents Iph1, Iph2 and Iph3 are the corresponding voltages V1x, Vsat and Vsat respectively. That is, the readout voltages Vout corresponding to the photocurrents Iph2 and Iph3 have reached the saturation voltage Vsat, which means that the readout voltages Vout corresponding to the photocurrents Iph2 and Iph3 cannot be used to measure the corresponding intensities of the detected light. Based on the integration period Td3, all the readout voltages Vout generated by the integration circuit 190 according to the photocurrents Iph1, Iph2 and Iph3 are equal to the saturation voltage Vsat. That is, all the readout voltages Vout corresponding to the photocurrents Iph1, Iph2 and Iph3 cannot be used to measure the corresponding intensities of the detected light.

Accordingly, except for setting a short integration period for the light detection system 100, the readout voltage Vout generated by the integration circuit 190 for detecting the light having high intensity is likely to reach the saturation voltage Vsat, which cannot be used to measure the intensity of the detected light. However, when a short integration period is set for measuring the light having high intensity, the readout voltage Vout generated for measuring the light having low intensity may become too small, and a corresponding signal to noise ratio (S/N ratio) will decrease to an unacceptable level. Under such situation, the noise tolerance of the light detection system 100 is also decreasing accordingly.

In order to solve the aforementioned problems concerning the light detection system 100, a variety of prior art light detection systems capable of measuring light in an extensive range of intensity are set forth. One of which is implemented by making use of a plurality of photo-inducing elements 110 having different sensitivities for detecting the light having different intensities. That is, a photo-inducing element 110 having low sensitivity is used for detecting the light having high intensity, and a photo-inducing element 110 having high sensitivity is used for detecting the light having low intensity. The other one of which is implemented by making use of a plurality of feedback capacitors Cfb having different capacitances corresponding to the light having different intensities. That is, the amplifier 130 in conjunction with a feedback capacitor Cfb having high capacitance is used for generating a readout voltage Vout corresponding to the light having high intensity. Alternatively, the amplifier 130 in conjunction with a feedback capacitor Cfb having low capacitance is used for generating a readout voltage Vout corresponding to the light having low intensity. Although the light detection system 100 with the aid of a plurality of selective components is able to measure light in an extensive range of intensity, the circuit complexity and production cost of the light detection system 100 will increase significantly.

### SUMMARY OF THE INVENTION

In accordance with an embodiment of the present invention, a light detection method is provided to avoid generating readout signals having saturation voltage resulting in sacrificing functionality of signal distinguishing while detecting light having high intensity. The light detection method comprises providing a plurality of integration periods, performing a light detection process for generating a light detection signal, selecting one of the integration periods according to the light detection signal, and generating a readout signal by performing an integration process on the light detection signal during the selected integration period.

The present invention further provides a light detection system for avoiding generating readout signals having saturation voltage resulting in sacrificing functionality of signal distinguishing while detecting light having high intensity. The light detection system comprises a light detection circuit, an integration-period control circuit, and an integration circuit. The light detection circuit is utilized for performing a light detection process so as to generate a light detection signal. The integration-period control circuit is coupled to the light detection circuit for generating a control signal based on the light detection signal. The integration circuit is coupled to the light detection circuit and the integration-period control circuit for adjusting an integration period based on the control signal. Besides, the integration circuit is utilized to perform an integration process on the light detection signal during the adjusted integration period so as to generate a readout signal.

In accordance with another embodiment of the present invention, a light detection method is provided to avoid generating readout signals having saturation voltage resulting in sacrificing functionality of signal distinguishing while detecting light having high intensity. The light detection method comprises setting a first preset voltage, performing a first light detection process for generating a first light detection signal, generating a first readout signal by performing a first integration process on the first light detection signal during the first integration period, and generating a second integration period by adjusting the first integration period based on the first readout signal and the first preset voltage, wherein the first preset voltage is substantially less than a saturation voltage.

The present invention further provides a light detection method for avoiding generating readout signals having saturation voltage resulting in sacrificing functionality of signal distinguishing while detecting light having high intensity. The light detection method comprises performing a light detection process for generating a light detection signal, generating a readout signal by performing an integration process on the light detection signal during an integration period, comparing a voltage of the readout signal with a preset voltage range, and calculating an output signal based on the integration period and the readout signal if the voltage of the readout signal is within the preset voltage range.

Furthermore, the present invention provides a light detection system for avoiding generating readout signals having saturation voltage resulting in sacrificing functionality of signal distinguishing while detecting light having high intensity. The light detection system comprises a light detection circuit, an integration circuit, a compare circuit, and an integration-period control circuit. The light detection circuit is utilized for performing a light detection process so as to generate a light detection signal. The integration circuit is coupled to the light detection circuit for generating a readout signal by performing an integration process on the light detection signal during an integration period. Besides, the integration circuit adjusts the integration period based on a first control signal. The compare circuit is coupled to the integration circuit for comparing the readout signal with at least one preset voltage so as to generate at least one compare signal. The integration-period control circuit is coupled to the compare circuit for generating a second control signal based on the at least one compare signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a prior art light detection system for use in a display apparatus.

FIG. 2 is a timing diagram schematically showing the relationship of the readout voltage versus time based on different photocurrents under operations of the light detection system in FIG. 1, having time along the abscissa.

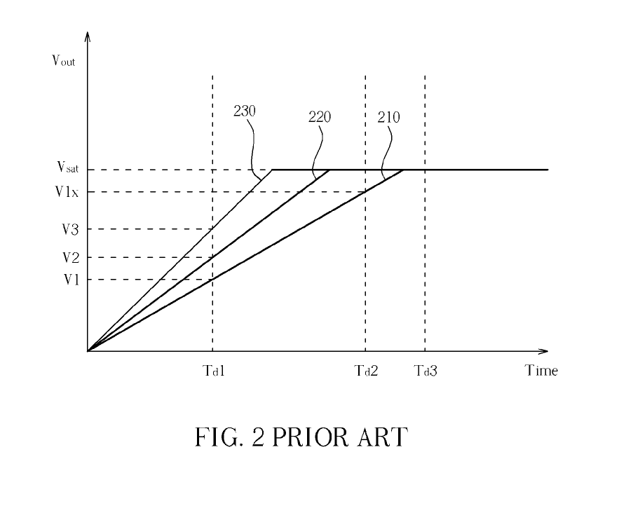

FIG. 3 is a functional block diagram schematically showing a light detection system in accordance with a preferred embodiment of the present invention.

FIG. 4 is a functional block diagram schematically showing a light detection system in accordance with another preferred embodiment of the present invention.

FIG. 5 is a flowchart depicting a light detection method in accordance with an embodiment of the present invention.

FIG. 6 is a flowchart depicting a light detection method in accordance with another embodiment of the present invention.

### DETAILED DESCRIPTION

Hereinafter, preferred embodiments of the present invention will be described in detail with reference to the accompanying drawings. Here, it is to be noted that the present invention is not limited thereto. Furthermore, the step serial numbers concerning the light detection method are not meant thereto limit the operating sequence, and any rearrangement of the operating sequence for achieving same functionality is still within the spirit and scope of the invention.

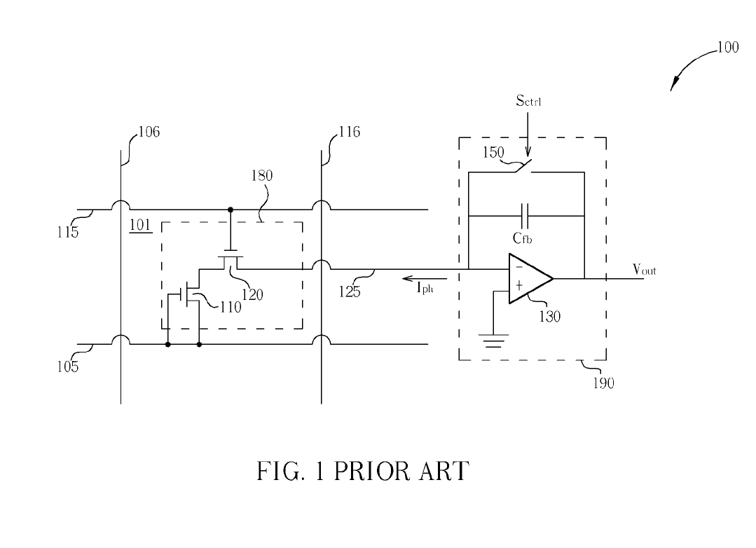

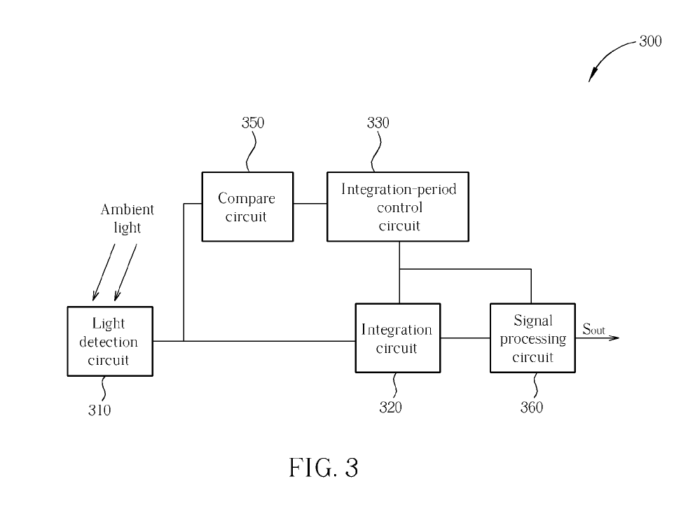

Please refer to FIG. 3, which is a functional block diagram schematically showing a light detection system 300 in accordance with a preferred embodiment of the present invention. The light detection system 300 comprises a light detection circuit 310, an integration circuit 320, an integration-period control circuit 330, a compare circuit 350, and a signal processing circuit 360. The light detection circuit 310 may comprise a photo-inducing element and a readout element similar to those shown in FIG. 1.

The photo-inducing element is used to detect the intensity of light for generating a light detection signal. The photo-inducing element can be a photo-inducing thin film transistor, a photo-inducing PMOS field effect transistor, a photo-inducing NMOS field effect transistor, a photo-inducing bipolar junction transistor, or a photodiode. The readout element is coupled to the photo-inducing element so as to control the process for outputting the light detection signal. The readout element can be a thin film transistor, a PMOS field effect transistor, an NMOS field effect transistor, or a bipolar junction transistor.

The compare circuit 350 is coupled to the light detection circuit 310 for receiving the light detection signal. The compare circuit 350 compares the intensity of the light detection signal with at least one preset light signal intensity for generating at least one compare signal. The integration-period control circuit 330 is coupled to the compare circuit 350 for receiving at least one compare signal so as to generate a control signal. The integration circuit 320 is coupled to the light detection circuit 310 and the integration-period control circuit 330 for receiving the light detection signal and the control signal respectively. The integration circuit 320 performs an integration process on the light detection signal for generating a readout signal. The length of the integration period of the integration process is controlled by the control signal. Furthermore, the integration circuit 320 is able to perform a reset operation for resetting the readout signal in response to the control signal.

The signal processing circuit 360 is coupled to the integration circuit 320 and the integration-period control circuit 330 for receiving the readout signal and the control signal respectively. The signal processing circuit 360 functions to perform a signal processing process for converting the readout signal into an output signal Sout. The output signal Sout may be generated through dividing the product of the voltage of the readout signal and a preset proportional value by the length of the integration period. Alternatively, the output signal Sout may be generated through dividing the voltage of the readout signal by the length of the integration period without the aid of the preset proportional value.

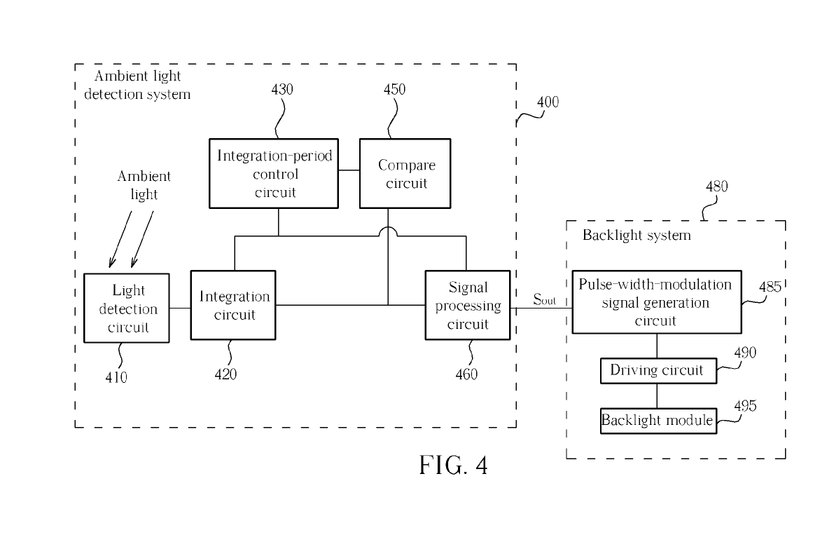

Please refer to FIG. 4, which is a functional block diagram schematically showing a light detection system 400 in accordance with another preferred embodiment of the present invention. The light detection system 400 comprises a light detection circuit 410, an integration circuit 420, an integration-period control circuit 430, a compare circuit 450, and a signal processing circuit 460. The light detection circuit 410 may comprise a photo-inducing element and a readout element similar to those shown in FIG. 1.

The photo-inducing element is used to detect the intensity of light for generating a light detection signal. The photo-inducing element can be a photo-inducing thin film transistor, a photo-inducing PMOS field effect transistor, a photo-inducing NMOS field effect transistor, a photo-inducing bipolar junction transistor, or a photodiode. The readout element is coupled to the photo-inducing element so as to control the process for outputting the light detection signal. The readout element can be a thin film transistor, a PMOS field effect transistor, an NMOS field effect transistor, or a bipolar junction transistor.

The integration circuit 420 is coupled to the light detection circuit 410 and the integration-period control circuit 430 for receiving the light detection signal and a control signal respectively. The integration circuit 420 performs an integration process on the light detection signal for generating a readout signal. The length of the integration period of the integration process is controlled by the control signal. Furthermore, the integration circuit 420 is able to perform a reset operation for resetting the readout signal in response to the control signal.

The compare circuit 450 is coupled to the integration circuit 420 for receiving the readout signal. The compare circuit 450 may comprise a first level comparator and a second level comparator. The first level comparator compares the voltage of the readout signal with a first preset voltage for generating a first compare signal. The first preset voltage is substantially less than a saturation voltage so as to avoid generating readout signals having saturation voltage resulting in sacrificing functionality of signal distinguishing. The second level comparator compares the voltage of the readout signal with a second preset voltage for generating a second compare signal. The second preset voltage is used to avoid generating readout signals having tiny voltage resulting in unacceptable low noise tolerance of the light detection system 400. The second preset voltage is less than the first preset voltage. In one embodiment, the compare circuit 450 may comprise only the first level comparator and is utilize only to avoid generating readout signals having saturation voltage resulting in sacrificing functionality of signal distinguishing.

The integration-period control circuit 430 is coupled to the compare circuit 450 for receiving the first compare signal and the second compare signal so as to generate the control signal. The control signal is utilized to control the length of an integration period concerning the integration process. Besides, the control signal also functions to enable a reset operation upon finishing the integration process. For instance, when the voltage of the readout signal is greater than the first preset voltage, the control signal generated based on the first compare signal is able to shorten the length of the integration period. Alternatively, when the voltage of the readout signal is less than the second preset voltage, the control signal generated based on the second compare signal is able to extend the length of the integration period. Furthermore, while finishing the integration process in an integration period, the control signal is used to enable a reset operation of the integration circuit 420 for resetting the readout signal. The integration-period control circuit 430 may further generate an output enable signal. The output enable signal is enabled when the voltage of the readout signal falls into the voltage range between the first preset voltage and the second preset voltage.

In another embodiment, the compare circuit 450 may comprise a window comparator. The window comparator compares the voltage of the readout signal with a preset voltage range between the first preset voltage and the second preset voltage for generating a first compare signal and a second compare signal. For instance, when the voltage of the readout voltage falls into the preset voltage range, both the first and second compare signals become low-level signals. When the voltage of the readout signal is greater than the first preset voltage, the first compare signal becomes a high-level signal and the second compare signal becomes a low-level signal. When the voltage of the readout signal is less than the second preset voltage, the first compare signal becomes a low-level signal and the second compare signal becomes a high-level signal. Accordingly, when the first compare signal is a high-level signal and the second compare signal is a low-level signal, the integration-period control circuit 430 generates the control signal for shortening the length of the integration period. When the first compare signal is a low-level signal and the second compare signal is a high-level signal, the integration-period control circuit 430 generates the control signal for extending the length of the integration period. When both the first and second compare signals are low-level signals, the integration-period control circuit 430 enables the output enable signal for enabling an output operation of the signal processing circuit 460.

Please note that the signal levels of the first and second compare signals corresponding to different readout signals are not limited to the aforementioned situations, and any circuit design having same functionality for adjusting the integration period based on the signal levels of the first and second compare signals corresponding to different readout signals is still within the spirit and scope of the invention.

The signal processing circuit 460 is coupled to the integration circuit 420 and the integration-period control circuit 430 for receiving the readout signal and the output enable signal respectively. When the output enable signal is enabled, the signal processing circuit 460 performs a signal processing process for converting the readout signal into an output signal Sout. The output signal Sout may be generated through dividing the product of the voltage of the readout signal and a preset proportional value by the length of the integration period. Alternatively, the output signal Sout may be generated through dividing the voltage of the readout signal by the length of the integration period without the aid of the preset proportional value.

Please continue referring to FIG. 4. The output signal Sout being generated can be utilized to control the operation of a backend circuit such as a backlight system 480 installed in a display apparatus. The backlight system 480 comprises a pulse width modulation signal generation circuit 485, a driving circuit 490, and a backlight module 495. The pulse width modulation signal generation circuit 485 is coupled to the signal processing circuit 460 for receiving the output signal Sout. The pulse width modulation signal generation circuit 485 generates a pulse width modulation signal having a duty cycle modulated in response to the output signal Sout. The driving circuit 490 is coupled to the pulse width modulation signal generation circuit 485 for generating a driving signal by amplifying the pulse width modulation signal. Accordingly, the backlight module 495 is able to output backlight having suitable intensity for a better visual experience based on the driving signal.

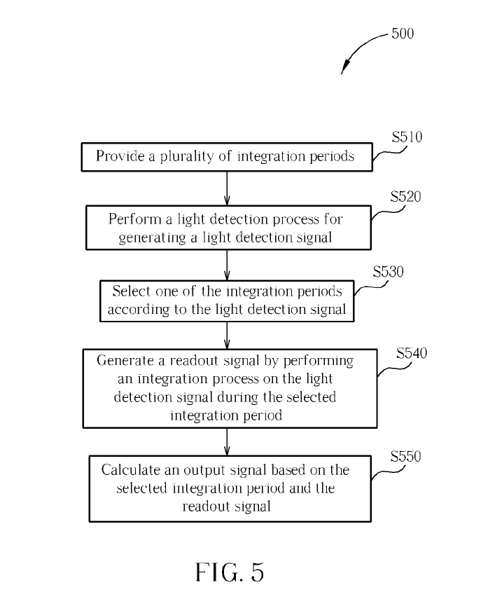

Please refer to FIG. 5, which is a flowchart depicting a light detection method 500 in accordance with an embodiment of the present invention. The light detection method 500 comprises the following steps:
Step S510: provide a plurality of integration periods;
Step S520: perform a light detection process for generating a light detection signal;
Step S530: select one of the integration periods according to the light detection signal;
Step S540: generate a readout signal by performing an integration process on the light detection signal during the selected integration period; and
Step S550: calculate an output signal based on the selected integration period and the readout signal.

In the light detection method 500 described above, the step S510 may comprise providing a first integration period, a second integration period, and a preset light signal intensity. The length of the first integration period is greater than the length of the second integration period. In the step S520, performing the light detection process for generating the light detection signal is detecting the intensity of light by a photo-inducing element for generating the light detection signal. The outputting of the light detection signal can be controlled by a readout element.

In the step S530, selecting one of the integration periods according to the light detection signal is selecting the first integration period when the intensity of the light detection signal is less than the preset light signal intensity, and selecting the second integration period when the intensity of the light detection signal is not less than the preset light signal intensity. In the step S540, performing the integration process on the light detection signal during the selected integration period for generating the readout signal comprises performing the integration process on the light detection signal during the selected first or second integration period for generating the readout signal having a voltage less than a saturation voltage. The step S540 may further comprise resetting the readout signal when the integration process is finished.

In the step S550, calculating the output signal based on the selected integration period and the readout signal may comprise a normalizing process for calculating the output signal through dividing the voltage of the readout signal by the length of the selected integration period. Alternatively, the step S550 may comprise another normalizing process for calculating the output signal through dividing the product of the voltage of the readout signal and a preset proportional value by the length of the selected integration period. In summary, the light detection method 500 is capable of selecting a better integration period for generating a readout signal having a voltage less than the saturation voltage, and calculating an output signal corresponding to the intensity of light based on the readout signal and the selected integration period.

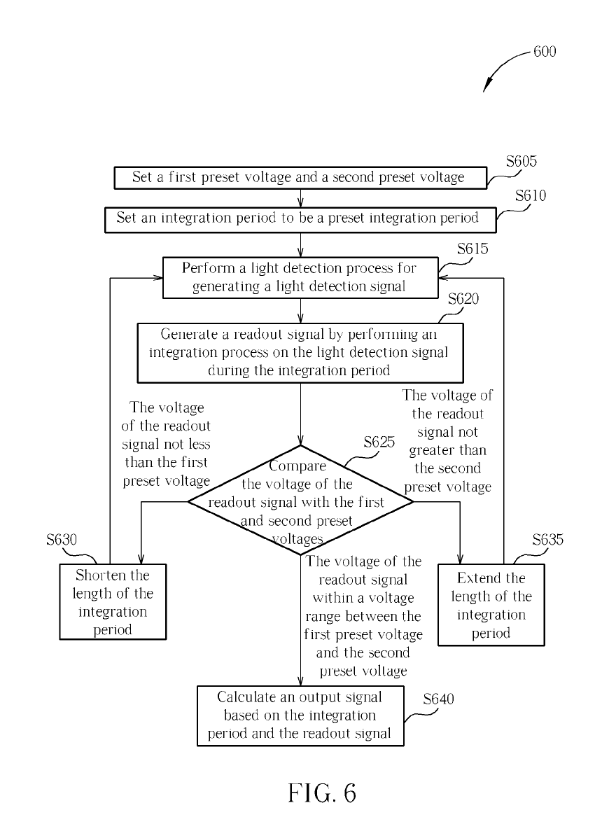

Please refer to FIG. 6, which is a flowchart depicting a light detection method 600 in accordance with another embodiment of the present invention. The light detection method 600 comprises the following steps:
Step S605: set a first preset voltage and a second preset voltage, wherein the first preset voltage is greater than the second preset voltage;
Step S610: set an integration period to be a preset integration period;
Step S615: perform a light detection process for generating a light detection signal;
Step S620: generate a readout signal by performing an integration process on the light detection signal during the integration period;
Step S625: compare the voltage of the readout signal with the first and second preset voltages, if the voltage of the readout signal falls into the voltage range between the first preset voltage and the second preset voltage, go to step S640; if the voltage of the readout signal is not less than the first preset voltage, go to step S630; if the voltage of the readout signal is not greater than the second preset voltage, go to step S635;
Step S630: shorten the length of the integration period, go back to step S615;
Step S635: extend the length of the integration period, go back to step S615; and
Step S640: calculate an output signal based on the integration period and the readout signal.

In the light detection method 600 described above, the first preset voltage cited in the step S605 is less than a saturation voltage. The process including the steps from S615 to S635 functions to limit the voltage of the readout signal to within the voltage range between the first preset voltage and the second preset voltage so as to avoid generating the readout signal having saturation voltage resulting in sacrificing functionality of signal distinguishing, and also to avoid generating the readout signal having tiny voltage resulting in unacceptable low noise tolerance. In the step S615, performing the light detection process for generating the light detection signal is detecting the intensity of light by a photo-inducing element for generating the light detection signal. The outputting of the light detection signal can be controlled by a readout element.

In the step S620, generating the readout signal by performing the integration process on the light detection signal during the integration period comprises performing the integration process on the light detection signal during the integration period being shortened or extended for generating the readout signal by an integration circuit. The step S620 may further comprise resetting the readout signal when the integration process is finished.

In the step S625, comparing the voltage of the readout signal with the first and second preset voltages comprises generating a first compare signal through comparing the readout signal with the first preset voltage by a first level comparator, generating a second compare signal through comparing the readout signal with the second preset voltage by a second level comparator, and determining whether the voltage of the readout signal is within the voltage range between the first preset voltage and the second preset voltage, whether the voltage of the readout signal is not less than the first preset voltage, or whether the voltage of the readout signal is not greater than the second preset voltage based on the first and second compare signals. Alternatively, in another embodiment, the step S625 may comprise generating the first and second compare signals through comparing the readout signal with the first and second preset voltages by a window comparator, and determining whether the voltage of the readout signal is within the voltage range between the first preset voltage and the second preset voltage, whether the voltage of the readout signal is not less than the first preset voltage, or whether the voltage of the readout signal is not greater than the second preset voltage based on the first and second compare signals.

When the voltage of the readout signal is not less than the first preset voltage, the step S630 is performed for shortening the length of the integration period so as to avoid generating the readout signal having saturation voltage resulting in sacrificing functionality of signal distinguishing. When the voltage of the readout signal is not greater than the second preset voltage, the step S635 is performed for extending the length of the integration period so as to avoid generating the readout signal having tiny voltage resulting in unacceptable low noise tolerance. When the voltage of the readout signal is within the voltage range between the first and second preset voltages, the step S640 is performed for calculating the corresponding output signal based on the integration period and the readout signal.

The step S640 may comprise a normalizing process for calculating the output signal through dividing the product of the voltage of the readout signal and a preset proportional value by the length of the integration period. Alternatively, the step S640 may comprise another normalizing process for calculating the output signal through dividing the voltage of the readout signal by the length of the selected integration period without the aid of the preset proportional value. In summary, the light detection method 600 is capable of adjusting the integration period for generating a readout signal having a voltage within a preset voltage range, and calculating an output signal corresponding to the intensity of light based on the readout signal and the adjusted integration period.

As a result, the light detection system and method of the present invention can be utilized to measure light in an extensive range of intensity by merely making use of integration-period control related circuits for providing integration periods appropriate for the integration process. In one aspect, the event of generating a readout signal having saturation voltage will not occur to the integration process, and the intensity of light can be measured precisely. In another aspect, the event of generating a readout signal having tiny voltage will also not occur to the integration process, and acceptable noise tolerance can be persisted. That is, based on extra simple circuits for providing integration periods appropriate for the integration process, the light detection process for measuring light accurately in an extensive range of intensity can be implemented.

The present invention is by no means limited to the embodiments as described above by referring to the accompanying drawings, which may be modified and altered in a variety of different ways without departing from the scope of the present invention. Thus, it should be understood by those skilled in the art that various modifications, combinations, sub-combinations and alternations might occur depending on design requirements and other factors insofar as they are within the scope of the appended claims or the equivalents thereof.

What is claimed is:

1. A light detection method comprising:
providing a plurality of integration periods;
performing a light detection process for generating a light detection signal;
selecting one of the integration periods according to the light detection signal; and
generating a readout signal by performing an integration process on the light detection signal during the selected integration period.

2. The light detection method of claim 1, wherein the step of providing the plurality of integration periods comprises providing a first integration period and a second integration period, the first integration period being greater than the second integration period.

3. The light detection method of claim 2, further comprising:
setting a preset light signal intensity; and
calculating an output signal based on the selected integration period and the readout signal;
wherein the step of selecting one of the integration periods according to the light detection signal comprises selecting the first integration period when the intensity of the light detection signal is less than the preset light signal intensity; and the step of generating the readout signal by performing the integration process on the light detection signal during the selected integration period comprises performing the integration process on the light detection signal during the first integration period for generating the readout signal having a voltage lower than a saturation voltage.

4. The light detection method of claim 3, wherein the step of selecting one of the integration periods according to the light detection signal comprises selecting the second integration period when the intensity of the light detection signal is not less than the preset light signal intensity; and the step of generating the readout signal by performing the integration process on the light detection signal during the selected integration period comprises performing the integration process on the light detection signal during the second integration period for generating the readout signal having a voltage lower than the saturation voltage.

5. The light detection method of claim 3, wherein the step of calculating the output signal based on the selected integration period and the readout signal comprises calculating the output signal through dividing the product of the voltage of the readout signal and a preset proportional value by a length of the selected integration period.

6. A light detection system comprising:
a light detection circuit for performing a light detection process so as to generate a light detection signal;
an integration-period control circuit coupled to the light detection circuit for generating a control signal based on the light detection signal; and
an integration circuit coupled to the light detection circuit and the integration-period control circuit for adjusting an integration period based on the control signal, and for performing an integration process on the light detection signal during the adjusted integration period so as to generate a readout signal.

7. The light detection system of claim 6, further comprising:
a compare circuit coupled between the light detection circuit and the integration-period control circuit for comparing an intensity of the light detection signal with a preset light signal intensity so as to generate a compare signal; and
a signal processing circuit coupled to the integration circuit and the integration-period control circuit for calculating an output signal based on the readout signal and the adjusted integration period;
wherein the integration-period control circuit generates the control signal based on the compare signal.

8. A light detection method comprising:
setting a first preset voltage;
performing a first light detection process for generating a first light detection signal;
generating a first readout signal by performing a first integration process on the first light detection signal during the first integration period; and
generating a second integration period by adjusting the first integration period based on the first readout signal and the first preset voltage;
wherein the first preset voltage is substantially less than a saturation voltage.

9. The light detection method of claim 8, wherein generating the second integration period by adjusting the first integration period based on the first readout signal and the first preset voltage is generating the second integration period by shortening a length of the first integration period when a voltage of the first readout signal is not less than the first preset voltage.

10. The light detection method of claim 8, further comprising:
performing a second light detection process for generating a second light detection signal;
generating a second readout signal by performing a second integration process on the second light detection signal during the second integration period; and
calculating an output signal based on the second integration period and the second readout signal if a voltage of the second readout signal is less than the first preset voltage.

11. The light detection method of claim 10, wherein the step of calculating the output signal based on the second integration period and the second readout signal comprises calculating the output signal through dividing the product of the voltage of the second readout signal and a preset proportional value by a length of the second integration period.

12. The light detection method of claim 8, further comprising:
setting a second preset voltage, wherein the second preset voltage is less than the first preset voltage.

13. The light detection method of claim 12, wherein the step of generating the second integration period by adjusting the first integration period based on the first readout signal and the first preset voltage comprises generating the second integration period by adjusting the first integration period based on the first readout signal, the first preset voltage, and the second preset voltage.

14. The light detection method of claim 13, wherein generating the second integration period by adjusting the first integration period based on the first readout signal, the first preset voltage, and the second preset voltage is generating the second integration period by shortening a length of the first integration period when a voltage of the first readout signal is not less than the first preset voltage.

15. The light detection method of claim 13, wherein generating the second integration period by adjusting the first integration period based on the first readout signal, the first preset voltage, and the second preset voltage is generating the second integration period by extending a length of the first integration period when a voltage of the first readout signal is not greater than the second preset voltage.

16. The light detection method of claim 13, further comprising:
performing a second light detection process for generating a second light detection signal;
generating a second readout signal by performing a second integration process on the second light detection signal during the second integration period; and
calculating an output signal based on the second integration period and the second readout signal if a voltage of the second readout signal is within a voltage range between the first preset voltage and the second preset voltage.

17. The light detection method of claim 16, wherein the step of calculating the output signal based on the second integration period and the second readout signal comprises calculating the output signal through dividing the product of the voltage of the second readout signal and a preset proportional value by a length of the second integration period.

18. A light detection method comprising:
performing a light detection process for generating a light detection signal;
generating a readout signal by performing an integration process on the light detection signal during an integration period;
comparing a voltage of the readout signal with a preset voltage range; and
calculating an output signal based on the integration period and the readout signal if the voltage of the readout signal is within the preset voltage range.

19. The light detection method of claim 18, wherein comparing the voltage of the readout signal with the preset voltage range is comparing the voltage of the readout signal with a preset voltage; and calculating the output signal based on the integration period and the readout signal if the voltage of the readout signal is within the preset voltage range is calculating the output signal based on the integration period and the readout signal if the voltage of the readout signal is less than the preset voltage.

20. The light detection method of claim 18, wherein comparing the voltage of the readout signal with the preset voltage range is comparing the voltage of the readout signal with a first preset voltage and a second preset voltage; and calculating the output signal based on the integration period and the readout signal if the voltage of the readout signal is within the preset voltage range is calculating the output signal based on the integration period and the readout signal if the voltage of the readout signal is within the preset voltage range between the first preset voltage and the second preset voltage.

21. A light detection system comprising:
a light detection circuit for performing a light detection process so as to generate a light detection signal;
an integration circuit coupled to the light detection circuit for generating a readout signal by performing an integration process on the light detection signal during an integration period, the integration period being adjusted based on a first control signal;
a compare circuit coupled to the integration circuit for comparing the readout signal with at least one preset voltage so as to generate at least one compare signal; and
an integration-period control circuit coupled to the compare circuit for generating a second control signal based on the at least one compare signal.

22. The light detection system of claim 21, wherein the compare circuit comprises a first level comparator coupled to the integration circuit for comparing the readout signal with a first preset voltage so as to generate a first compare signal.

23. The light detection system of claim 22, wherein the integration-period control circuit generates the second control signal based on the first compare signal.

24. The light detection system of claim 22, wherein the compare circuit further comprises a second level comparator coupled to the integration circuit for comparing the readout signal with a second preset voltage so as to generate a second compare signal, the second preset voltage being less than the first preset voltage.

25. The light detection system of claim 24, wherein the integration-period control circuit generates the second control signal based on the first compare signal and the second compare signal.
